(19) United States
(12) Patent Application Publication
(10) Pub. No.: US 2014/0053725 A1
(43) Pub. Date: Feb. 27, 2014

(54) Helium Junction with Replaceable Graphene Cartridges

(71) Applicant: Saudi Arabian Oil Company, Dhahran (SA)

(72) Inventor: Conrad Keene Allen, Dhahran (SA)

(21) Appl. No.: 13/934,755

(22) Filed: Jul. 3, 2013

Related U.S. Application Data
(60) Provisional application No. 61/691,997, filed on Aug. 22, 2012.

(51) Int. Cl. C02F 1/20; B01D 19/00

(52) U.S. Cl. CPC C02F 1/20; B01D 19/0031
USPC 95/46; 96/6

(57) ABSTRACT

A helium separation junction is provided for separating helium gases entrained in aqueous fluids. The junction includes a body, an inlet for receiving an aqueous feedstock having helium entrained therein, a helium outlet for allowing a helium gas stream, an aqueous fluid outlet for allowing a water stream having a reduced helium content relative to the feedstock, a helium filter cartridge that allows for the passage of helium while resisting the passage of water and an aqueous fluid filter cartridge that allows for the passage of water while resisting the passage of helium.

### RELATED APPLICATIONS

This application claims priority to U.S. provisional patent application Ser. No. 61/691,997, filed on Aug. 22, 2012, the disclosure of which is incorporated herein by reference in its entirety.

### FIELD OF THE INVENTION

This invention relates to a method and apparatus for the removal of entrained gases from fluids. More specifically, this invention relates to a method and apparatus for the removal of entrained helium from water and hydrocarbon fluids.

### BACKGROUND OF THE INVENTION

Radioactively decaying rocks continuously emit energized alpha particles into contiguous rock strata. Some alpha particles become isotopic or elemental helium by taking on electrons from the strata itself or from bound fluid. When helium concentrations amass in fluid bearing strata, the aggregate fluid can be produced to the surface where the crude helium can be separated therefrom.

In the course of the exploration and development of scarce and natural resources, particularly in exploring for and producing hydrocarbons, non-associated gases are commonly encountered. These non-associated gases, for example helium, can be extremely scarce and very valuable. For example, helium is over 25 times more valuable than methane. Frequently, during the production of hydrocarbons, helium is produced by accident, along with the primary targets of methane and oil. When there is no plant or method in place to recover the helium from hydrocarbon fluids and gases during production, this valuable resource simply passes through the refinery system and most commonly is vented into the atmosphere.

Today, crude helium can be worth more than $80 USD/mcf, and when refined can bring greater than $120 USD/mcf. Thus, a method for the capture and recovery of helium during the production of hydrocarbon is needed.

### SUMMARY OF THE INVENTION

Generally, an apparatus for the separation of helium entrained in aqueous fluids is provided.

In one aspect, a helium separation junction for the separation of helium gas from aqueous feedstock having helium gas entrained therein is provided. The helium separation junction includes a body having an inlet, for receiving an aqueous feedstock having helium gas entrained therein and two outlets. A helium outlet is for allowing helium gas to be removed. An aqueous fluid outlet is provided for allowing a liquid stream having a helium concentration that is less than the concentration of helium in the aqueous feedstock to pass through. A helium filter cartridge positioned upstream of the helium outlet, wherein the helium filter cartridge allows for helium gas to pass through while resisting passage of liquids therethrough. An aqueous fluid filter cartridge is positioned upstream of the aqueous fluid outlet, wherein the aqueous fluid. cartridge allows for liquids to pass through the aqueous fluid filter cartridge, while at the same time resisting passage of helium gas therethrough.

In certain embodiments, the aqueous fluid filter cartridge includes a graphene membrane. in certain embodiments, the aqueous fluid filter cartridge includes a graphene body. In certain embodiments, the helium filter cartridge includes a rubber membrane, In certain embodiments, the helium filter cartridge includes a rubber body. In certain embodiments, the helium outlet is connected to a helium collection chamber. In certain embodiments, a valve is positioned between the helium outlet and the helium collection chamber to prevent the backflow of helium into the helium separation junction. In certain embodiments, the body of the helium separation. junction. is constructed of steel In certain embodiments, the liquid stream removed by the aqueous fluid outlet comprises water. In certain embodiments, the helium separation junction further includes a feedstock supply line, the feedstock supply line comprising a turbulent flow device configured to induce turbulent flow in the aqueous feedstock. in certain embodiments, the turbulent flow device is a series of internal, out of phase, helical

In another aspect of the invention, a method for the removal and recovery of helium from an aqueous fluid having helium entrained therein is provided. The method includes the step of supplying an aqueous fluid to a helium separation junction. The helium separation junction includes a body, which includes an inlet, a helium outlet, and an aqueous fluid outlet, where the helium outlet allows a helium gas stream to pass through and the aqueous fluid outlet allows a purified water stream having entrained helium removed therefrom to pass through. The method further includes the step of contacting the aqueous fluid with a helium filter cartridge positioned upstream of the helium outlet and an aqueous fluid filter cartridge positioned upstream of the aqueous fluid outlet. The helium filter cartridge includes a helium separation membrane operable to allow the passage of helium white resisting the flow of the aqueous fluid, such that a helium gas stream flows through the helium outlet. The aqueous fluid filter cartridge includes an aqueous fluid separation membrane operable to allow the passage of the aqueous fluid while resisting the flow of helium, such that a purified water stream flows through the aqueous fluid outlet, the purified water stream having a reduced content of helium relative to the aqueous fluid supplied to the helium separation junction. The method further includes the step of recovering a helium gas stream and the purified water stream.

In certain aspects of the present invention, the helium separation junction is a Y-junction. in certain aspects of the present invention, the aqueous fluid having helium entrained therein is supplied via a feedstock supply line, the feedstock supply line comprising helical coils therein, the helical coils being operable to create turbulent flow.

### BRIEF DESCRIPTION OF THE DRAWINGS

FIG. 1 is a partial cross sectional view of a piping layout of one embodiment of a helium separation junction,

FIG. 2 is a cross sectional view of one embodiment of an helium separation junction for separating helium from water.

### DETAILED DESCRIPTION OF THE INVENTION

Although the following detailed description contains many specific details for purposes of illustration, it is understood that one of ordinary skill in the art will appreciate that many examples, variations and alterations to the apparatus and methods described herein are within the scope and spirit of the invention. Accordingly, the exemplary embodiments of the invention described herein are set forth without any loss of generality, and without imposing limitations, on the claimed invention.

In one aspect, the invention relates to an apparatus for the separation of entrained gases from aqueous fluids. The apparatus can be a helium separation junction for use in a pipeline or other mid-stream application, wherein aqueous fluids with entrained gases supplied to the device can be separated into liquid and gas phases. In certain embodiments, the aqueous fluid is a feedstock. In certain embodiments, the entrained gas in the aqueous fluid can be helium. In some embodiments, the liquid phase can be water, brine, or any other liquid present during hydrocarbon production operations. In certain embodiments, the gas phase, can be helium. In certain embodiments, two or more helium separation junctions can be employed in series.

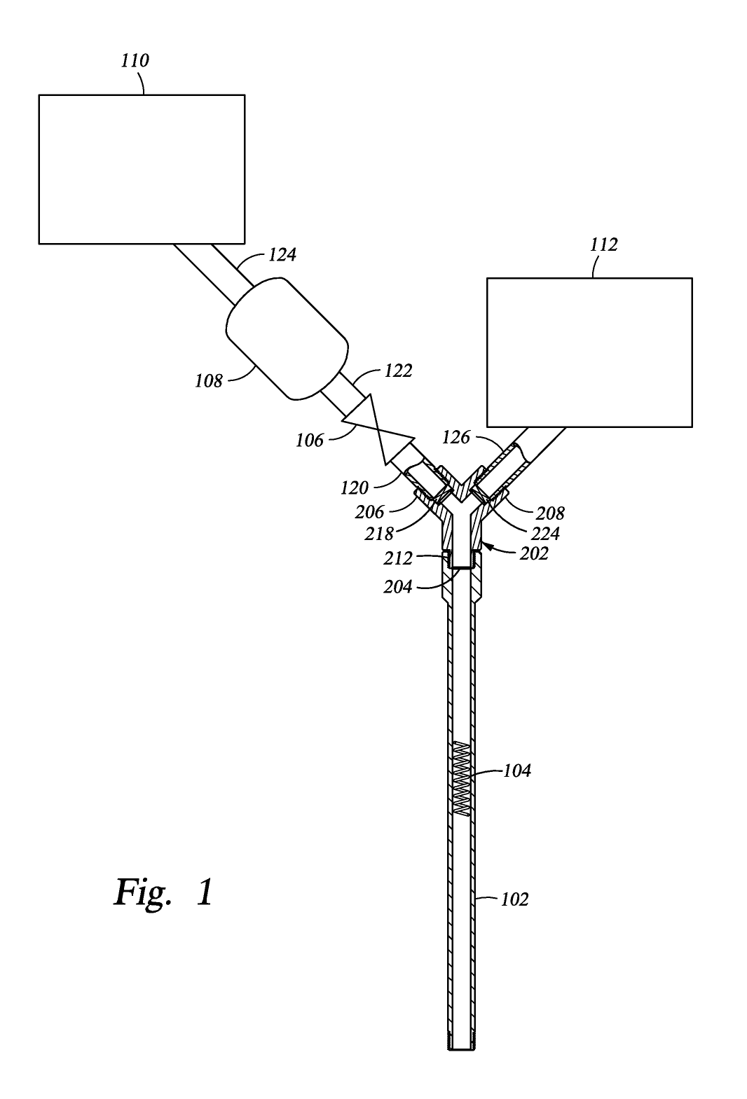

100151 In one embodiment, a helium separation junction is provided. Referring to FIG. 1, body 202 is connected to feedstock supply line 102 that supplies an aqueous fluid with entrained helium to inlet 204. In some embodiments, feedstock supply line 102 can be a production flow line from a drilling rig or production platform. Feedstock supply line 102 can be pipe connected to body 202 by known means, such known means include male and female pipe connection threads, welds. In at least one embodiment, body 202 can be connected to feedstock supply line 102 with male connection threads 212.

Body 202 of helium separation junction can be produced from or encased in a steel (or other like material) housing suitable to withstand high pressure flow. In alternate embodiments, for example in low pressure applications other materials such as plastic, can be utilized for the construction of the helium separation junction. The helium separation junction typically includes male threaded connection 212 at inlet 204 for field production inflow and female threaded connections at helium outlet 206 and aqueous fluid outlet 208 outflow to gas and fluid handling systems. It is understood that the device can be configured in multiple configurations with respect to the use of male and/or female threaded connections for the inlet and outlets of the device. Quick access to the interior of the helium separation junction can be accomplished by removing the series of bolts around the steel housing.

Feedstock supply line 102 can include turbulent flow device 104 for inducing turbulent flow upstream of inlet 204. Turbulent flow is desirable to ensure sufficient mixing of the fluids. In some embodiments, turbulent flow device 104 can include coils, a mixer, a vortex generator, an orifice, or like device. In an alternate embodiment, turbulent flow device 104 can include a series of internal, out of phase, helical coils. in certain embodiments, the helical coils serve to prime the fluid supplied thereto for separation of entrained helium. The supply line leading into the inlet of the separation junction can include out of phase helical coils, which cause turbulent flow of the fluids.

Helium filter cartridge 218 is connected to helium outlet 206. In accordance with an embodiment of the present invention, the helium separation junction produces a helium gas stream. Helium outlet 206 can be connected to helium collection chamber 108 for the collection of helium gas that has passed through helium filter cartridge 218. In accordance with one embodiment of the present invention, valve 106, such as a pressure actuated ball valve, can be installed between helium outlet 206 and helium collection chamber 108 to prevent backflow of captured gas into the helium separation junction. Valve 106 can be used to prevent backflow of helium whereby the helium that has passed through helium filter cartridge 218 passes into the helium collection chamber 108 once sufficient pressure has built up. Helium connection chamber 108 can be connected downstream to a standard gaseous phase handling system 110. In an alternate embodiment of the present invention, helium can be collected in helium collection chamber 108 until a desired pressure is reached, at which time helium connection chamber 108 can be flushed and the collected helium released to gaseous handling system 110. The purpose of helium collection chamber 108 or gaseous phase handling system 110 is the recovery of the gases once separated from the aqueous fluids in helium separation junction. In an alternate embodiment of the present invention, helium outlet 206, valve 106, helium collection chamber 108, and gaseous handling system 110 can be connected with pipe sections 120, 122, and 124. One of skill in the art will appreciate that the diameter, length, and layout of pipe sections 120, 122, and 124 can be dictated by the layout of the process, including the locations of the helium separation junction and the various recovery systems. One of skill in the art will appreciate the need to include piping between the different recovery systems.

Aqueous fluid filter cartridge 224 is connected to aqueous fluid outlet 208. Aqueous fluid outlet 208 can be connected to liquid handling system 112 for the treatment of any liquid that has passed through aqueous fluid filter cartridge 224. The type of liquid handling system depends on the liquid stream flowing from aqueous fluid outlet 208. In an alternate embodiment of the present invention, aqueous fluid outlet 208 can be connected to pipe section 126. One of skill in the art will appreciate that the diameter, length, and layout of pipe section 126 can be dictated by the layout of the process, including the locations of the helium separation junction and liquid handling system 112. The purpose of liquid handling system 112 and pipe section 126 is the recovery of the liquids once separated from the entrained gases in the helium separation junction.

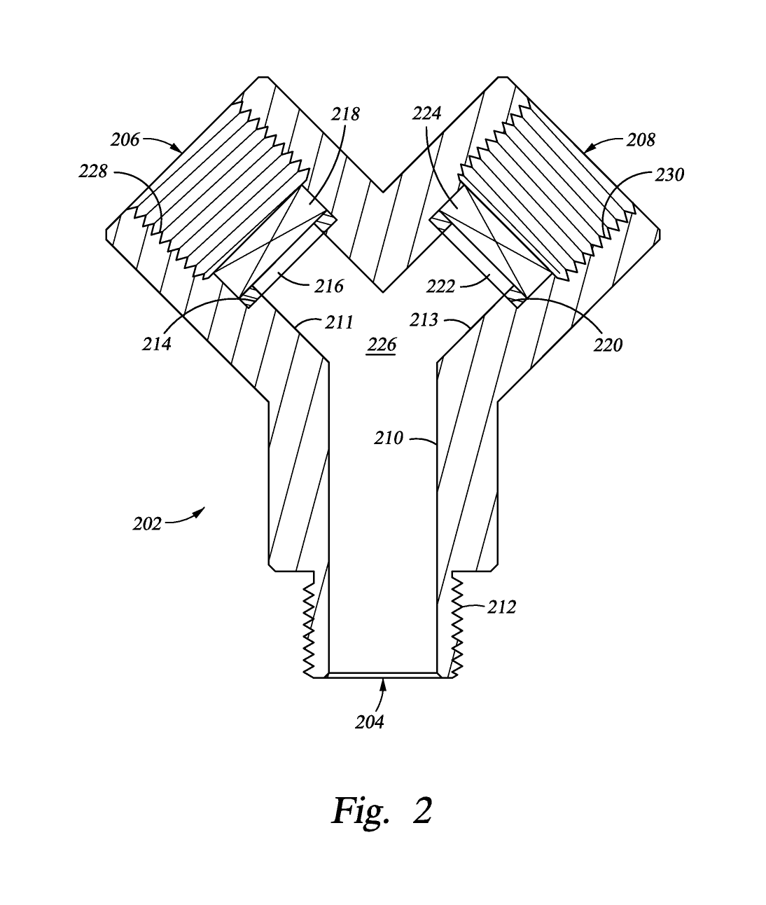

Referring to FIG. 2, a cross sectional view of the helium separation junction is provided. The aqueous fluid with entrained helium enters body 202 at inlet 204. Inlet 204 connects to annular passage 210. Annular passage 210 connects inlet 204 through body 202 to Y-junction 226. Inlet 204 and annular passage 210 supply the aqueous fluid with entrained helium to Y-junction 226.

Y-junction 226 splits into helium passage 211 and aqueous passage 213. Helium passage 211 connects Y-junction 226 to helium filter cartridge 218. Aqueous passage 213 connects Y-junction 226 to aqueous fluid separation membrane 222.

Helium passage 211 is connected to helium filter cartridge 218. filter cartridge 218 is configured to allow the passage of entrained gases, including helium from helium passage 211 to helium outlet 206. Helium filter cartridge 218 is configured to resist the passage of aqueous fluids. In certain embodiments of the present invention, helium filter cartridge 218 resists all or substantially all of the passage of aqueous fluids. Helium filter cartridge 218 is positioned within helium replaceable filter slot 214. Helium replaceable filter slot 214 is located downstream of helium passage 211 and upstream of helium outlet 206. Helium replaceable filter slot 214 allows for access to helium filter cartridge 218 for the removal of spent cartridges and replacement with fresh cartridges. Helium replaceable filter slot 214 can include engineered slots in body 202 with tongue and groove sealing edges, or a shoulder. Helium replaceable filter slot 214 can be held in place by a series of fastening bolts accessible from the exterior of body 202. Helium filter cartridge 218 can optionally include seals and/or gaskets, as needed, to ensure a secure fit of helium filter cartridge 218 within helium replaceable filter slot 214. In an embodiment of the present invention, helium filter cartridge 218 includes a rubber gasket and body. In an alternate embodiment, helium replaceable filter slot 214 is accessible from helium outlet 206. Helium filter cartridge 218 can include helium separation membrane 216. Helium separation membrane 216 contacts the aqueous fluid with entrained helium present in helium passage 211. Helium separation membrane 216 allows the passage of helium without allowing the passage of the aqueous fluid. Helium filter cartridge 218 can be made of any substance which allows the passage of entrained gases, such as helium, while restricting the passage of liquids there through. In at least one embodiment of the present invention, helium filter cartridge 218 includes a rubber body. In at least one embodiment of the present invention, helium separation membrane 216 is a rubber membrane.

Helium filter cartridge 218 is connected to helium outlet 206. Helium outlet 206 can include any known connection means, including male or female pipe thread connections or welds. As shown, helium outlet 206 includes female connection threads 228. In certain embodiments, male connection threads can be used.

The removal of helium from water used in production operations is valuable beyond just the commodity value of the helium itself. In certain embodiments, the use of the helium separation junction described herein can reduce resource intensive refining costs and operation time. For example, helium frequently becomes concentrated in certain Paleozoic groundwater formations, and the cost of pumping the helium charged groundwater to the refinery for separation is costly. Thus, the use of the apparatus described herein can eliminate this step and thus no valuable refinery time would be consumed to remove the helium from the water as the helium removal device can remove helium from water at the field level. This would eliminate the need to transport the water to a refinery or other location for stripping of the helium, leaving the stripped water at the rig site. In certain embodiments, the helium separation junction can provide a helium stream having sufficient purity that the need for refinery step entirely, in some instances, and go straight to a designated storage facility, either by truck, ship or pipeline.

Aqueous passage 213 is connected to aqueous fluid filter cartridge 224. Aqueous fluid filter cartridge 224 is configured to allow the passage of liquids from aqueous passage 213 to aqueous outlet 208. Aqueous fluid filter cartridge 224 is configured to resist the passage of an entrained gas, for example helium. In certain embodiments, aqueous fluid filter cartridge 224 is configured to resist the passage of all entrained gases. In certain embodiments, aqueous fluid filter cartridge 224 is configured to resist the passage of a target entrained gases. In at least one embodiment of the present invention, aqueous fluid filter cartridge 224 is configured to resist the passage of helium. In at least one embodiment of the present invention, aqueous fluid fitter cartridge 224 resists the passage of all or substantially all of entrained gas present in the aqueous fluid. Aqueous fluid filter cartridge 224 is positioned within aqueous fluid replaceable filter slot 220. Aqueous fluid replaceable filter slot 220 is located downstream of aqueous passage 213 and upstream of aqueous fluid outlet 208. Aqueous fluid replaceable titter slot 220 allows access to aqueous fluid filter cartridge 224 for the removal of spent cartridges and insertion of fresh cartridges. Aqueous fluid replaceable filter slot 220 can include engineered slots in body 202 with tongue and groove sealing edges, or a shoulder. Aqueous fluid replaceable filter slot 220 can be held in place by a series of fastening bolts accessible from the exterior of body 202. Aqueous fluid filter cartridge 224 can optionally include seals and/or gaskets, as needed to ensure a secure tit of aqueous fluid filter cartridge 224 within aqueous fluid replaceable filter slot 220. In an embodiment of the present invention, aqueous fluid replaceable filter slot 220 is accessible from aqueous fluid outlet 208. Aqueous fluid fitter cartridge 224 can include aqueous fluid separation membrane 222. Aqueous fluid separation membrane 222 contacts the aqueous fluid with entrained helium present in aqueous passage 213. Aqueous fluid separation membrane 222 allows the passage of liquid without allowing the passage of helium, or other entrained gases.

Aqueous fluid filter cartridge 22.4 can be made of any substance which allows the passage of liquids, while restricting the passage of gases there through. In at least one embodiment of the present invention, aqueous fluid filter cartridge 224 is constructed from a graphene body. In at least one embodiment of the present invention, aqueous fluid separation membrane 222 is a graphene membrane. The graphene used in aqueous fluid filter cartridge 224 and aqueous fluid separation membrane 222 can be a mesh designed to specifically restrict the flow of helium and allow the liquid to pass. Graphene, an allotrope of carbon, typically has a one-atom-thick planar sheet-like structure of sp²-banded carbon atoms. The graphene atoms form a densely packed honeycomb crystal lattice. Graphene is stronger than diamond; thus, replacement of graphene filters, membranes, and/or fitter cartridges because of wear is typically not required. The use of graphene filters, membranes, and/or filter cartridges reduces or eliminates expensive and time consuming replacement procedures that typically require flow line switching. Graphene has been shown to selectively filter helium. In one embodiment of the present invention, graphene occurs in the absence of a powder. In some embodiments, aqueous fluid separation membrane 222 can be a series of thin graphene sheets, such that the flow of the aqueous fluid is through the sheets. The number of sheets in aqueous fluid separation membrane, depend on the composition of the fluid and the helium concentration, with more sheets being used for high helium concentrations. In use, the design in certain embodiments allows for interchanging of the replaceable filter cartridges located at outlets 206 and 208, as needed.

Aqueous fluid filter cartridge 224 is connected to aqueous fluid outlet 208. Aqueous fluid outlet 208 can include any known connection means, including male or female pipe thread connections or welds. As shown, aqueous fluid outlet 208 includes female connection threads 230. In certain embodiments, male connection threads can be used.

The helium separation junction can be scaled to fit standard production pipe sizes. In certain embodiments, the helium separation junction includes five main components: a feed pipe having interior helical coils configured to cause turbulent flow in the fluids being supplied; a pressurized chamber in a steel housing having one inlet and two or more outlet ports; filter cartridges consisting of at least one graphene cartridge for the passage of stripped water and at least one rubber cartridge for the production of helium; helium collection chamber having pressure ball valve to prevent backflow and connection means to standard gaseous phase handling system; and a connection pipe having a ball valve for preventing backflow for supplying stripped water to standard fluid handling system.

In another aspect, a method is provided for the removal and recovery of helium entrained in an aqueous fluid using the helium separation junction. The aqueous fluid supplied to inlet 204 of body 202 is water with helium entrained. The liquid leaving aqueous fluid outlet 208 is water. The water stream produced from the helium separation junction has a helium concentration that is less than the concentration of the helium in the aqueous feedstock. The water can be collected and further purified (if desired), or can be supplied to an alternate process.

The aqueous fluid passes through annular passage 211 to Y-junction 226 before contacting helium separation membrane 216 and aqueous fluid separation membrane 222. The helium passes through helium separation membrane 216 to helium replaceable filter cartridge 218. The helium then passes through helium replaceable filter cartridge 218 to helium outlet 206. Helium outlet 206 produces a helium gas stream. The water passes through aqueous fluid separation membrane 222 to aqueous fluid replaceable filter cartridge 224. The water then passes through aqueous fluid replaceable filter cartridge 224 to aqueous fluid outlet 208. Aqueous fluid outlet 208 produces a water stream having entrained helium removed therefrom.

In accordance with one embodiment of the present invention, by using the presently described device, a purified water stream having a decreased helium concentration, relative to the aqueous feedstock, can be produced, while at the same time recovering helium gas.

In certain embodiments, interchanging of the outlet filter cartridge can re-direct the helium and aqueous flow. In certain embodiments, two or more helium separation devices can be installed in series for increased production rates. In certain embodiments when helium production may be low, the graphene cartridges can be removed and utilized in adjacent fields; for example, when a field is temporarily idled, the graphene cartridge could be flexed to another field to increase helium production.

The methods and devices provided herein solve several problems that are frequently encountered with the recovery of water from oil and gas exploration and production operations, and provide a means for the capture of helium gases. The methods and devices provided herein operate to separate helium from an aqueous fluid by using pressure gradients, in the absence of any electrical current or induced electrical current.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made herein.

As used herein and in the appended claims, the words “comprise,” “has,” and “include” and all grammatical variations thereof are each intended to have an open, non-limiting meaning that does not exclude additional elements or steps.

As used herein, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present invention.

That which is claimed is:

1. A helium separation junction for the separation of helium gas from aqueous feedstock having helium gas entrained therein, the apparatus comprising:
a body, the body having an inlet, for receiving an aqueous feedstock having helium gas entrained therein, an aqueous fluid outlet, the aqueous fluid outlet for allowing a liquid stream having a helium concentration that is less than the concentration of helium in the aqueous feedstock to be removed, and a helium outlet, the helium outlet for allowing a helium gas to be removed;
a helium filter cartridge positioned upstream of the helium outlet, wherein the helium filter cartridge allows for helium gas to pass through while resisting the passage of liquids therethrough; and
an aqueous fluid filter cartridge positioned upstream of the aqueous fluid outlet, wherein the aqueous fluid filter cartridge allows for liquids to pass through while resisting passage of helium gas therethough.

2. The helium separation junction of claim 1, wherein the aqueous fluid filter cartridge includes a graphene membrane.

3. The helium separation junction of claim 1, wherein the aqueous fluid filter cartridge includes a graphene body.

4. The helium separation junction of claim 1, wherein the helium filter cartridge includes a rubber membrane.

5. The helium separation junction of claim 1, wherein the helium filter cartridge includes a rubber body.

6. The helium separation junction of claim 1, wherein the helium outlet is connected to a helium collection chamber.

7. The helium separation junction of claim 1, wherein a valve is positioned between the helium outlet and the helium collection chamber to prevent the backflow of helium into the helium separation junction.

8. The helium separation junction of claim 1, wherein the body of the helium separation junction is constructed of steel.

9. The helium separation junction of claim 1, wherein the liquid stream removed by the aqueous fluid outlet comprises water.

10. The helium separation junction of claim 1, further comprising a feedstock supply line, the feedstock supply line comprising a turbulent flow device configured to induce turbulent flow in the aqueous feedstock.

11. The helium separation junction of claim 10, wherein the turbulent flow device is a series of internal, out of phase, helical coils.

12. A method for the removal and recovery of helium from an aqueous fluid having helium entrained therein, the method comprising:
supplying an aqueous fluid to a helium separation junction, the helium separation junction comprising a body comprising an inlet, a helium outlet, and an aqueous fluid outlet,
wherein the helium outlet allows a helium gas stream to pass through and the aqueous fluid outlet allows a purified water stream to pass through;
contacting the aqueous fluid with a helium filter cartridge positioned upstream of the helium outlet and an aqueous fluid filter cartridge positioned upstream of the aqueous fluid outlet, the helium filter cartridge comprising a helium separation membrane operable to allow the passage of helium while resisting the flow of the aqueous fluid and the aqueous fluid filter cartridge comprising an aqueous fluid separation membrane operable to allow the passage of the aqueous fluid while resisting the flow of helium, such that a helium gas stream flows through the helium outlet and a purified water stream flows through the aqueous fluid outlet, the purified water stream having a reduced content of helium relative to the aqueous fluid supplied to the helium separation junction; and
recovering the helium gas stream and the purified water stream.

13. The method of claim 11, wherein the helium separation junction is a Y-junction.

14. The method of claim 11, wherein the aqueous fluid having helium entrained therein is supplied via a feedstock supply line, the feedstock supply line comprising helical coils therein, the helical coils being operable to create turbulent flow.
